(19) United States
(12) Patent Application Publication
(10) Pub. No.: US 2002/0178243 A1
(43) Pub. Date: Nov. 28, 2002

(54) Apparatus and method for centrally managing network devices

(76) Inventor: Kevin Collins, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/858,025

(22) Filed: May 15, 2001

(51) Int. Cl. G06F 15/173; G06F 15/16

(52) U.S. Cl. 709/223; 709/203

(57) ABSTRACT

An apparatus and method for centrally managing a number of network devices. The invention may comprise determining whether a device interface for each of the number of devices conforms with a standard interface. In the event the device interface does not conform to the standard interface, it may first be translated to conform thereto. As such, the device may be managed according to the standard interface. Managing the device may include, for example, monitoring the device, alerting an administrator in response to an event, obtaining device attributes, etc.

### FIELD OF THE INVENTION

The invention generally pertains to the management of network devices, and more particularly to centrally managing a number of network devices according to a standard interface.

### BACKGROUND OF THE INVENTION

Individual devices, such as, personal computers (PCs), storage devices, servers, etc., are often interconnected to one another over one or more networks. Local area networks (LANs) are often used to interconnect devices within a closed environment (e.g., an office). Wide area networks (WANs) are often used to interconnect devices between remote environments (e.g., corporate departments via an intranet or even the Internet). Networks may also include both LANs and WANs linked to one another for various purposes. In addition, entire networks may be dedicated to specific devices and/or functions (e.g., a storage area network (SAN)).

A user accessing the network expects the network to perform for the intended purpose. For example, the user expects a network storage device to be available for storing and/or retrieving data; a network printer to be available for printing; a router to properly route a request to the WAN; etc. Therefore an administrator, using one or more suitable monitoring applications, must monitor the network for potential and/or actual failures and correct these failures, preferably transparently to the user accessing the network.

A number of network management applications are available to monitor networks. For example, Hewlett-Packard's Network Node Manager (NNM) (Hewlett-Packard Company, Corporate Headquarters, Palo Alto, Calif.) discovers devices present on the network and provides a graphical display of the network structure. When a network failure occurs, an event correlation engine evaluates the event stream and alerts the administrator of the cause of the failure. As such, an administrator is able to determine and initiate the appropriate action to correct the failure. Correcting the failure may involve taking a network component off-line and/or replacing a failed network component, reinitializing, or otherwise configuring one or more devices on the network by accessing the respective device management application (DMA) for “soft” configuration thereof.

Each DMA is typically device-specific (i.e., it is based on a device interface). As such, the administrator must have access to each individual DMA for each device on the network so that the administrator may configure the device to correct or prevent a failure of the device, and hence, at least a portion of the network. With the development of larger, more complex networks, however, there is a greater need for central, standard management of each of the devices on the network. In addition, current arrangements only alert the administrator that a problem, or a potential problem, exists on the network. The administrator must then determine and initiate the appropriate corrective action.

### SUMMARY OF THE INVENTION

The inventors have devised an apparatus and method for centrally managing a number of network devices according to a standard interface. In addition, the invention may also be integrated into a network management application to manage the devices on the network.

An apparatus for centrally managing a number of network devices is preferably embodied in computer readable program code. The apparatus may comprise program code for determining whether a device interface for each of the devices conforms with a standard interface. For example, the device interface may contain common or recognizable data strings (e.g., text or ASCII combinations, etc.) which are readily identified and thus conforms to the standard interface. Where the device interface does not conform to the standard interface, program code may further be provided for translating the device interface to a standard format. For example, an interface for a legacy device that does not contain readily recognizable data strings may not be supported by the standard interface. As such, a translation library may be provided that contains device-specific data strings provided by the manufacturer or otherwise determined that can be mapped to the standard interface. In any event, program code may also be provided for managing the devices according to the standard interface. Preferably, the program code for managing comprises program code for monitoring the device. For example, program code may be provided for listening for a device trap (e.g., an error signal) from the device. Program code may also be provided for notifying an administrator when a device trap is received. In addition, the program code for managing may also comprise program code for obtaining the attributes of the device.

Also disclosed is a method for centrally managing a number of devices on a network using a standard interface. The method may comprise determining whether the device interface conforms to the standard interface. Where the device is nonconforming, the device interface may first be translated. In any event, the standard interface may be used for managing the device.

Management may comprise monitoring the device. For example, an administrator may be notified in response to receiving a device trap. Or for example, the attributes of the device may be obtained, and/or changed.

As such, each device on the network can be centrally managed via a standard interface. When new devices are added to the network, these too can be centrally managed by the administrator via the standard interface. In addition, the standard interface may be integrated with a management application so that various management functions can be initiated.

These and other important advantages and objectives of the present invention will be further explained in, or will become apparent from, the accompanying description, drawings and claims.

### BRIEF DESCRIPTION OF THE DRAWINGS

An illustrative and presently preferred embodiment of the invention is illustrated in the drawings in which:

FIG. 1 is a high-level diagram showing various devices on a network and a management module for central management thereof;

FIG. 2 is a high-level functional diagram showing the various components of the management module;

FIG. 3 is a flowchart illustrating a method for centrally managing the devices;

FIG. 4 illustrates a notification interface displayed by the management module;

FIG. 5 illustrates a network selection interface displayed by the management module;

FIG. 6 illustrates a device selection interface displayed by the management module based on the network selected using the network selection interface of FIG. 5;

FIG. 7 illustrates a device properties interface displayed by the management module based on the device selected using the device selection interface of FIG. 6; and

FIG. 8 illustrates an attributes interface displayed by the management module when an attributes selection is made using the device properties interface of FIG. 7.

### DESCRIPTION OF THE PREFERRED EMBODIMENT

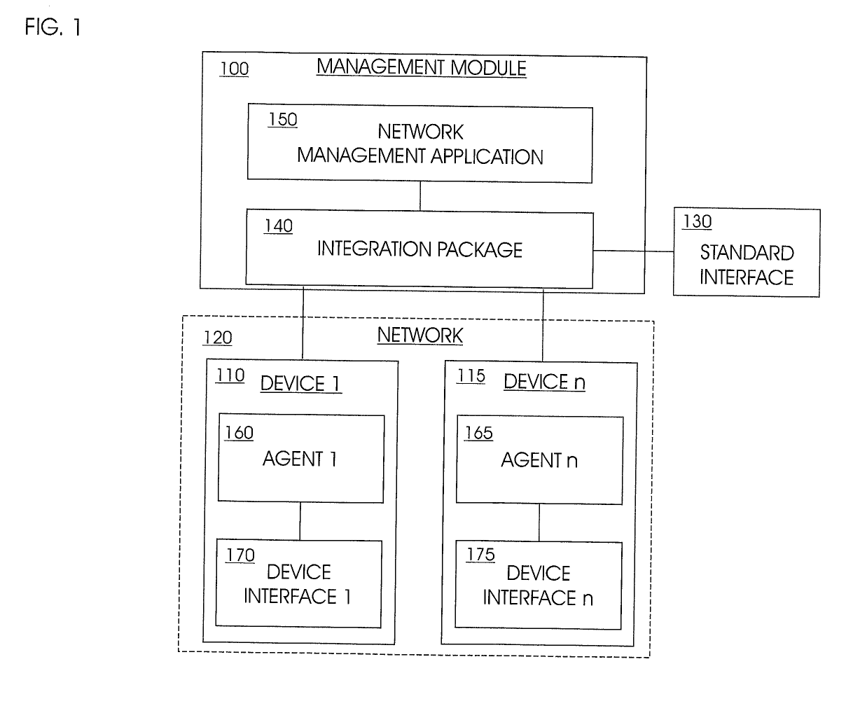

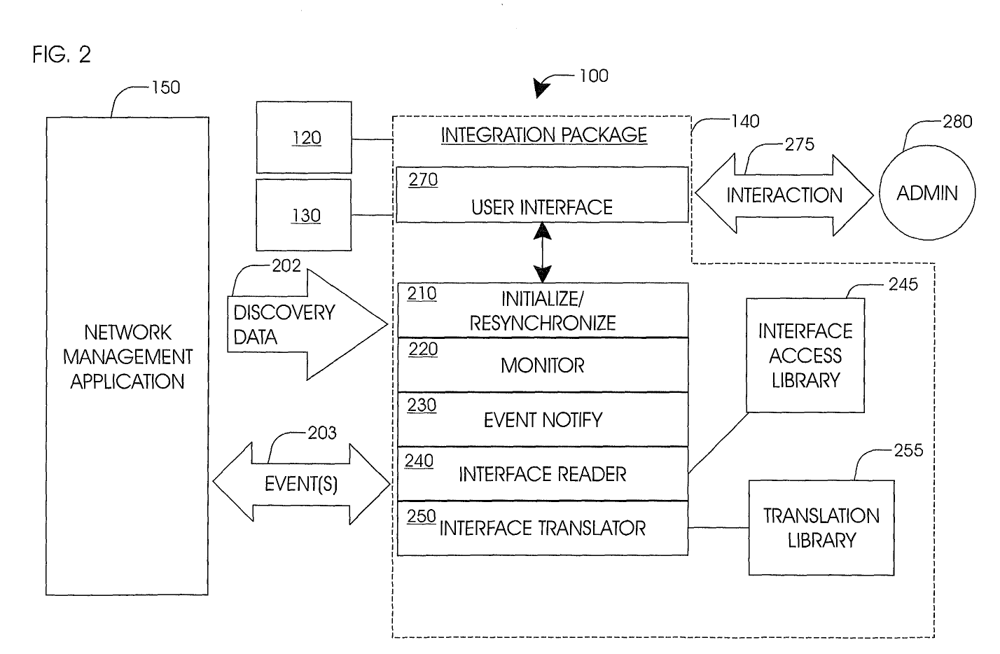

An embodiment of the management module 100 according to the teachings of the invention is shown in FIG. 1 for centrally managing a number of (i.e., one or more) devices 110, 115 on a network 120 using a standard interface 130. Generally, the management module 100 (e.g., suitable program code, firmware, etc.) may comprise an integration package 140 and a network management application 150. An administrator may interact 275 (e.g., via a user interface 270; FIG. 2) with the management module 100 to monitor the devices 110, 115 on the network 120.

It is understood that the network 120 may be any suitable network (LAN, WAN, the Internet, etc.). Likewise, any number of devices 110, 115 may be linked to the network 120 via any suitable means (e.g., modem, T-1, digital subscriber line (DSL), infrared, etc.), through yet other devices (e.g., routers, hubs), other networks (e.g., LAN, Intranet), etc. Preferably, the devices 110, 115 are storage devices, such as, but not limited to, hard disk drives, zip disks, compact discs (CDs), magnetic tape drives, network area storage (NAS) devices, storage area networks (SANs), “just a bunch of disks” (JBOD), etc. However, it is to be understood that the devices 110, 115 may include, for example, but are not limited to, peripheral devices (e.g., printers, scanners), PCs, servers, routers, hubs, etc.

As an illustration, the network 120 may be monitored using a suitable network management application 150, such as NNM (Hewleft-Packard), TME (Tivoli Systems Inc., an IBM Company, Austin, Tex.), etc. When a device 110, 115 on the network 120 fails, the network management application 150 pinpoints the cause of the failure or potential failure. For example, the network management application 150 may alert the administrator of a network failure, and the administrator may determine that Device 1 (110) has failed. As such, the administrator may access the DMA corresponding to the failed device 110, which in turn may be used to configure the failed device 110 (i.e., via the device interface 170). Alternatively, and according to the teachings of the invention, a determination is made whether the device interface 170, 175 conforms to a standard interface 130, translated to conform thereto where the device interface 170, 175 is nonconforming (e.g., a proprietary interface), and the device may be centrally managed using the management module 100 according to the standard interface, as explained in more detail below.

The invention is preferably embodied in firmware and/or software (i.e., computer readable program code), generally referred to as the management module 100 and the standard interface 130. The management module 100 and standard interface 130 may be stored in any suitable computer readable storage media on the network 120.

The standard interface 130 is used to enable the management module 100. The standard interface 130 is preferably an application programming interface (API). That is, the standard interface 130 is a set of calling conventions by which the management module 150 accesses the device kernel, and other services. The API is preferably defined at the source code level and provides a level of abstraction at the management module 150 from the device kernel (or other device management utilities). In any event, the primary task of the standard interface is to provide a standard set of parameters readable by the management module 100 for the interpretation of call-by-value and call-by-reference arguments communicated between the devices 110, 115 and the management module 100.

The following definition of a standard interface 130 is given as an illustration as it may be written in the form of a management information base (MIB):

DeviceInfo

DeviceGlobalUniqueID

DeviceHealth

DeviceSysObjID

DeviceManagementURL

The “DeviceInfo” set identifies device-specific information in a standard format. For example, “DeviceGlobalUniqueID” is a value representing a globally unique identification for the device. The device ID (e.g., HPD123478765131) can be read as a character string from the device interface 170, 175 and mapped to or associated with the header “DeviceGlobalUniqueID” in the standard interface 130. Similarly, “DeviceHealth” is a value (e.g., “OK”) representing the overall health of the device. This object is intended to be a single poll point to check the status of the device 110, 115. “DeviceSysObjID” is a value (e.g., 1.3.6.1.4.11.10.4.3.2.1) representing the system object identity for the device 110, 115. Preferably, this value is an ASCII integer, and for single device agents, this field contains a value similar to the MIB II/System/sysObjID. “DeviceManagementURL” is a value (e.g., http://www.corp.com/StorageDevice1/index.htm) representing the uniform resource locator (URL) for the device management software. If it does not exist (e.g., there is no management software or the URL is not specified), the value is an empty string. This information may be read from the device interface 170, 175, according to the corresponding header in the standard interface 130 for use by the management module 100.

The standard interface 130 may also include “Trap Definitions” for identifying messages or traps received from the device 110, 115. The following is given as an illustration of a trap definition in the standard interface 130.

Trap Definitions

HealthTrap

The “HealthTrap” entry is a notification trap that indicates that the device's health has changed. The trap includes a description of the event in string format and the identity of the device 110, 115 involved. This allows the trap receiver to gain additional information about the device 110, 115 by accessing the device management software (DMA) for the corresponding device 110, 115.

It is understood that the above illustration of the standard interface 130 is given merely as an example. The standard interface 130 may take any suitable format, such as a MIB, coded using XML, CIM, etc. In addition, the standard interface 130 may include any suitable entries (e.g., device serial number, contact person, etc.), and is not limited to those illustrated above.

The management module 100 is shown in more detail in FIG. 2, and may generally comprise the network management application 150 and the integration package 140. The network management application 150 functionally interacts with the integration package 140 (e.g., at 202, and 203). For example, the integration package 140 may receive network data (e.g., IP address, etc.) from the network management application 150.

The integration package 140 may comprise an interface reader 240 and an interface translator 250. The interface reader 240 reads the device interface 170, 175 using an interface access library 245 and determines whether the device interface 170, 175 conforms to the standard interface 130. For example, the interface access library 245 may contain common or recognizable data strings (e.g., text or ASCII combinations, etc.) which are readily identified and thus conform to the standard interface 130. In some instances, the device interface 170, 175 may be nonconforming (i.e., it does not conform to the standard interface 130). For example, a device interface 170, 175 for a legacy device may not contain readily recognizable data strings, and therefore does not conform to the standard interface 130. Or for example, a device interface 170, 175 may be proprietary, and therefore is nonconforming.

Where the device interface 170, 175 is nonconforming, a translation library 255 is preferably provided that contains device-specific data strings and the corresponding standard data strings used by the standard interface 130. The device-specific data strings may be provided by the manufacturer, or otherwise determined. The interface translator 250 accesses the translation library 255 to map the attributes of the device interface 170, 175 from the device interface 170, 175 to conform to the standard interface 130. Once translated, the interface reader 240 may interpret the device interface 170, 175 (e.g., a translated version thereof) according to the standard interface 130 for use by the management module 100.

An exemplary translation library 255 may be as follows:

| Standard Attribute | Nonconforming Attribute |
|---|---|
| DeviceGlobalUniqueID | uuid |
| DeviceHealth | status |
| DeviceSysObjID | oid |
| DeviceManagementURL | url |

In the above example, the field “DeviceGlobalUniqueID” is mapped or translated to the field “uuid” in the nonconforming or noncompliant interface. That is, when the attribute “uuid” is read from the nonconforming interface, it is handled the same way the attribute “DeviceGlobalUniqueID” is handled in the standard interface 130. The remaining attributes shown above are similarly handled by the management module 100.

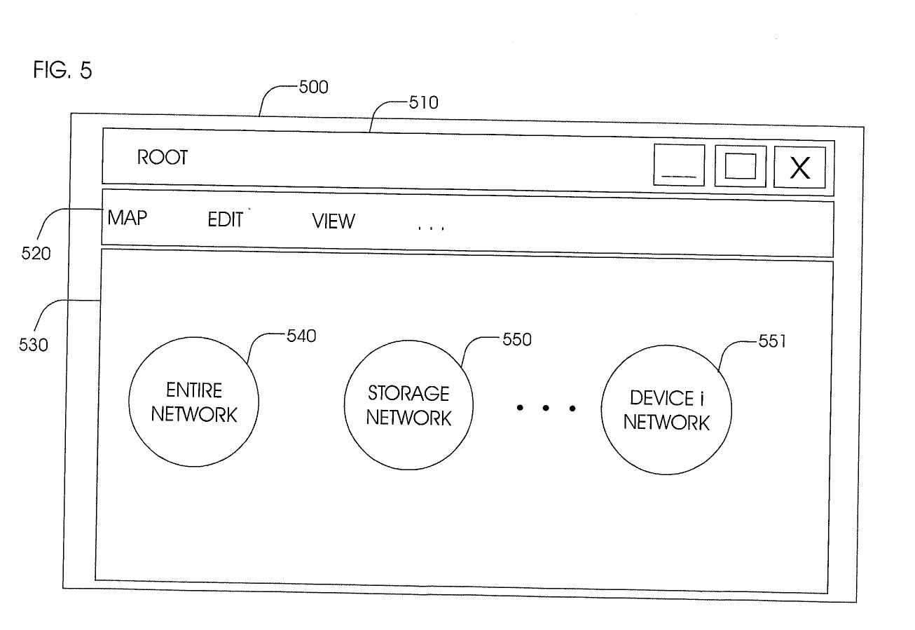

The integration package 140 may also comprise an initialize/resynchronize component 210, a monitor component 220, and an event notify component 230. These components may be functionally linked to the network management application 150 and are used in conjunction with the standard interface 130 to centrally manage the devices 110, 115. The initialize/resynchronize component 210 receives discovery data 202 (e.g., IP address, device ID, etc.) from the network management application 150 with respect to the devices 110, 115 on the network 120. This information may be displayed for the user via the user interface 270 and/or used by the other components to manage the devices 110, 115. For example, the monitor component 220 uses the discovery data 202 to monitor the devices 110, 115 on the network 120, and to determine device attributes as illustrated below with respect to FIG. 5 through FIG. 8. The monitor component 220 listens for messages or device traps (e.g., device failure, device error, etc.) from the devices 110, 115 on the network 120 via the standard interface 130. The event notify component 230 then notifies the administrator 280 of the status of the devices 110, 115 on the network 120.

It is understood that the components shown in FIG. 2 are merely illustrative of the functional components of a management module 100 and the program code need not be categorized as such. For example, the network management application 150 may be an existing application (e.g., NNM, TME). Or for example, the network management application 150 may be coded as part of the integration package 140. In addition, the integration package 140 may comprise more functional components than those shown in FIG. 2, or the functional components shown may be combined into one or more functional components. In addition, the program code may be a stand-alone application, may be a plug-in module or may be otherwise combined with an existing application and/or operating system, etc. Likewise, the management module 100, and/or one or more components thereof, may reside at one or more of the devices 110, 115, a workstation, a server, multiple locations on the network 120, etc.

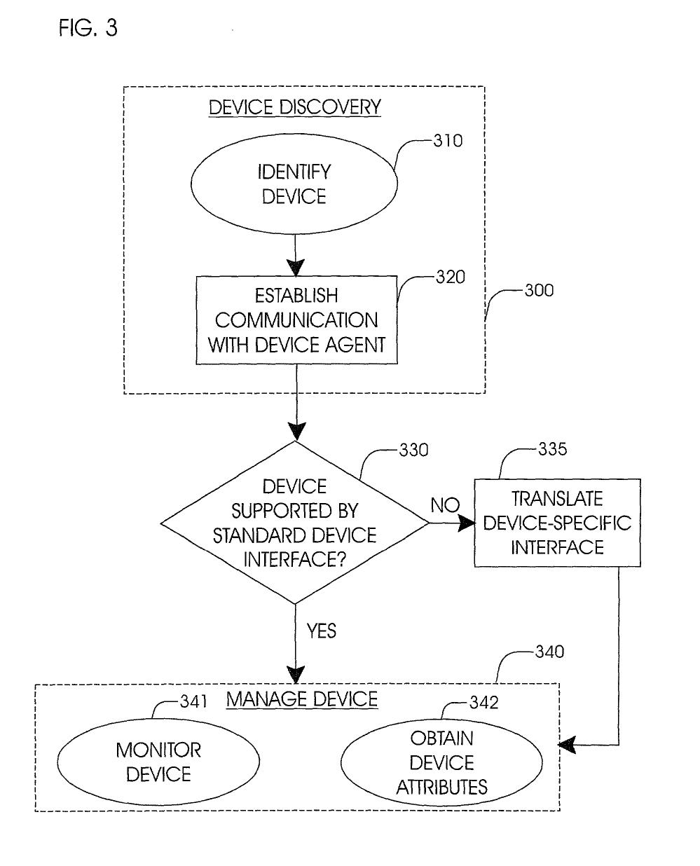

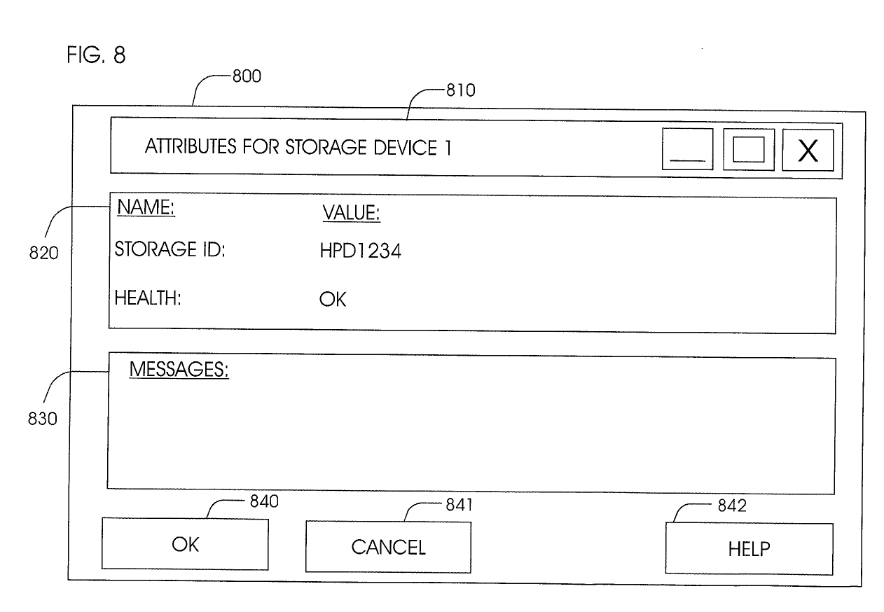

FIG. 3 is a flowchart illustrating an embodiment of a method for centrally managing the devices 110, 115 according to the teachings of the invention. Preferably, in step 300, the device 110, 115 is discovered on the network 120. The device 110, 115 may be discovered by identifying the device in step 310 and establishing communication with the device agent 160, 165. For example, an administrator may manually enter an IP address for the desired device 110, 115. Or for example, the integration package 140 may receive network discovery data from another application (e.g., network management application 150), etc. Communication is established with the device agent 160, 165 over the network 120 so that the device interface 170, 175 may be obtained from the device agent 160, 165 (e.g., for use by the reader 250). In step 330, a determination is made whether the device 110, 115 conforms to the standard interface 130. If the device interface 170, 175 conforms to the standard interface 130, the device 110, 115 may be managed in step 340. If the device interface 170, 175 in its current state does not conform to the standard interface 130 (i.e., it is nonconforming), the device interface 170, 175 is first translated in step 335 (e.g., using the translator 260) before proceeding to step 340. In any event, the device 110, 115 may be centrally managed (e.g., using the management module 100) in step 340. For example, the device 110, 115 may be monitored in step 341, such as for device traps. In another example, the attributes (e.g., device ID, device health, etc.; see FIG. 8) of the device 110, 115 may be obtained in step 342.

It is understood that the steps shown in FIG. 3 are merely illustrative of one embodiment of the method of the invention, and that other embodiments are also intended to be within the scope of the invention. Another embodiment may include additional steps. For example, the device 110, 115 may be configured using the standard interface to access the DMA for the device 110, 115 in response to receiving a trap. Other embodiments are also contemplated under the teachings of the invention.

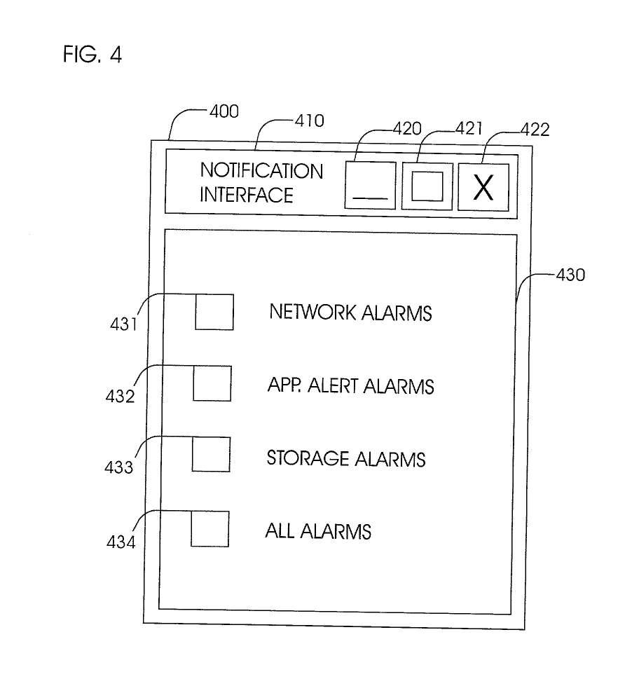

An exemplary embodiment of the management module 100 and the use thereof (e.g., via user interface 270) is illustrated using a notification interface 400 shown in FIG. 4. The exemplary notification interface 400 may be used for notifying an administrator 280 of events (e.g., device failure) related to the devices 110, 115. For example, various device alarms may be displayed in response to monitoring the devices 110, 115 on the network 120. The notification interface 400 is preferably a graphical user interface (GUI) that may comprise a title 410 (e.g., “ALARMS”) describing the interface 400 and may also comprise standard functional buttons 420-422 (e.g., “window minimize”, “window maximize”, and “window close”). A window 430 displays alarms that may result during monitoring of the devices 110, 115 using the management module 100.

Notification may include, for example, but is not limited to, network alarms (e.g., device error alarms, device threshold alarms, device status alarms, device configuration alarms, etc.) for notifying the administrator 280 of various device events. Other alarms may also include application alert alarms (representing events related to applications operating on the network), and storage alarms (representing events related to storage devices on the network). An “All Alarms” category may also be included that represents a summary of all events contained in the other alarm categories.

It is understood that the alarms interface 400 shown in FIG. 4 is merely exemplary and other embodiments are also contemplated as being within the scope of the invention. For example, various notifications 431-434 may be used to designate a device status. For example, various colored buttons can be used to indicate whether the alarm is idle, triggered, cleared, etc. In addition, the administrator may select a notification 431-434 (e.g., “pointing” and “clicking” one of the buttons with a PC mouse) to view additional details of the notification (e.g., the device ID and a specific problem or reason for the notification). It is also understood that the administrator 280 may be notified in any suitable manner, such as by pager, email, audible sound, a combination thereof, etc., and is not limited to the graphical user interface 400 shown and described with respect to FIG. 4.

Another embodiment of the management module 100 and the use thereof (e.g., via user interface 270) is illustrated in FIG. 5 through FIG. 8, wherein a device 110, 115 on the network is selected by the administrator 280 to obtain the attributes (e.g., device “health”, etc.) for the selected device 110, 115. For example, where the administrator 280 is notified of a potential or actual network device failure (e.g., via notification interface 400, FIG. 4), the administrator 280 may “drill down” to identify the particular device and the associated problem (see FIG. 5 through FIG. 8). Or as another example, the administrator 280 may select a particular device to review and change the attributes thereof when the device is upgraded (see FIG. 5 through FIG. 8).

A network selection interface 500 is shown in FIG. 5. The network selection interface 500 may include a title 510 (e.g., “root”), and a menu 520. The administrator may select various functions from the menu 520. For example, the administrator 280 may select “MAP” to initialize or resynchronize the network map displayed in the network window 530 (e.g., using initialize/resynchronize component 210). Preferably, the administrator 280 may directly select a network 540, 550, 551 from the network window 530. In the present illustration, the administrator 280 selects the storage network 550 (e.g., using a PC mouse).

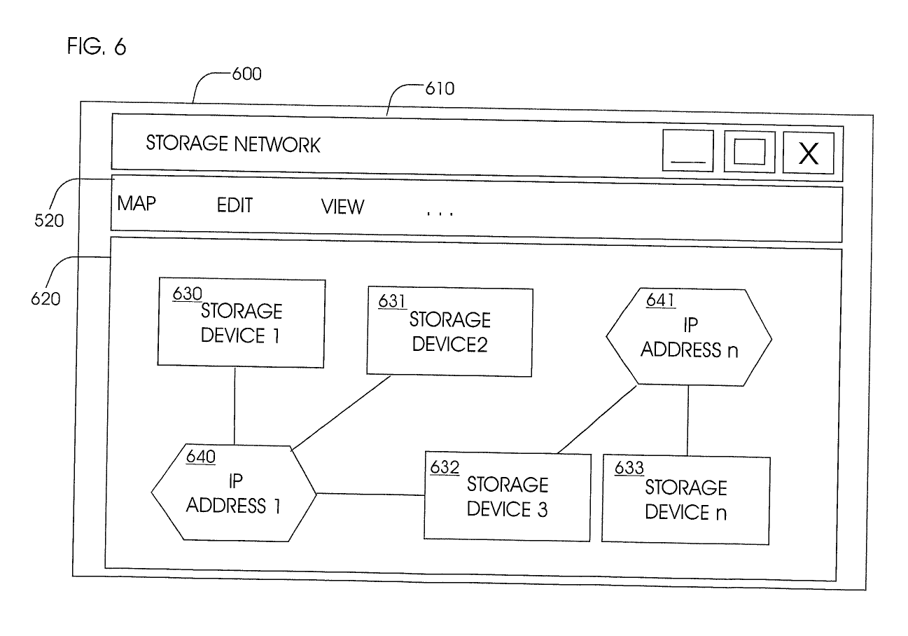

Once the storage network 550 is selected, a device selection interface 600 may be displayed by the management module 100, such as is shown in FIG. 6. The device selection interface 600 may comprise a title 610 (e.g., “Storage Network”) describing the interface, and a menu 520. In addition, the device selection interface 600 may comprise a device map displaying device icons 630-633 representing the devices 110, 115 of the selected storage network 550. Also preferably, the relation of the devices 110, 115 to the network 120 is shown, for example, by connecting links with the various router/hub icons 640, 641. The administrator 280 may select a particular device 110, 115 by pointing to and clicking on the respective device icon (e.g., “Storage Device 1” icon 630) using a PC mouse.

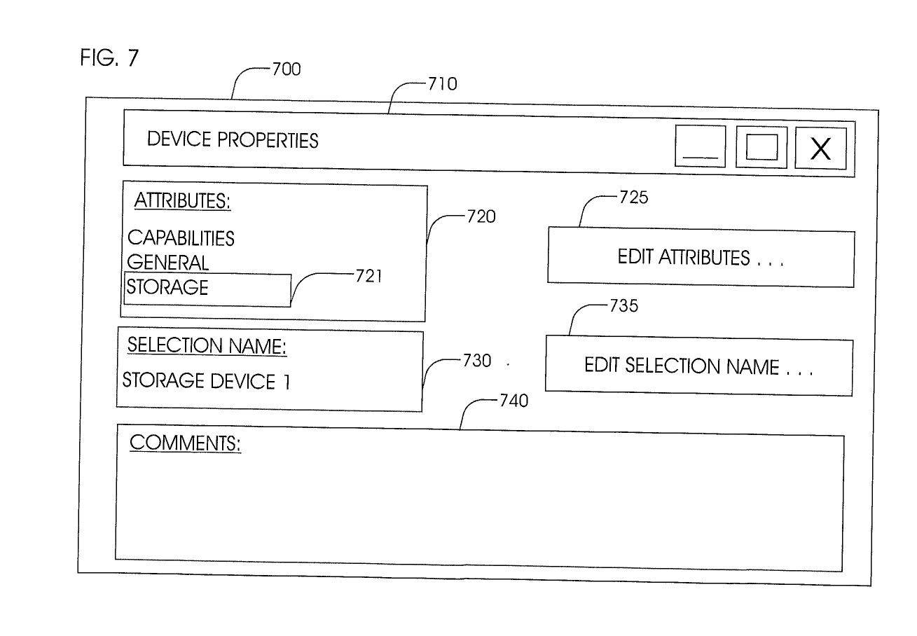

Once the administrator 280 selects a particular device 110, 115 (e.g., using the respective icon, e.g., 630), an object properties interface 700 may be displayed by the management module 100, such as is shown in FIG. 7. Again, the object properties user-interface 700 may comprise a title 710 (e.g., “Properties”). In addition, attributes 720 and device selection 730 are shown. In this example, “Storage Attributes” is shown highlighted 721, and specifically, “Storage Device 1” is shown selected at 730 (e.g., selected in FIG. 5 through FIG. 6). The administrator 280 may select other attributes 720 (e.g., capabilities, general, etc.), or obtain the attributes for the selected device 110, 115 (e.g., Storage Device 1) by pointing to and clicking on the edit attributes box 725 (e.g., using a PC mouse). In addition, the administrator 280 may change the name of the selected device 110, 115 (e.g., displayed at 730) with the edit name button 735. Comments 740 may display text for the selected device 110, 115 (e.g., “device driver version number 1.01”, “thirty gigabyte NAS device”, etc.).

Where the administrator selects the edit attributes button 725 in FIG. 7, an attributes interface 800 (FIG. 8) may be displayed by the management module 100. The attributes interface 800 may have a title 810 (e.g., “Attributes for Storage Device 1”). In addition, device attributes 820 may be displayed for the selected device 110, 115 (e.g., an attributes name and an associated value). Any messages pertaining to the selected device 110, 115 may also be displayed at 830 (e.g., active, offline, device failure at 12:12 a.m. on Jan. 12, 2000, etc.). In addition, standard functional buttons 840-842 may also be included, (e.g., OK, CANCEL, HELP, etc.).

It is understood that the illustration of FIG. 5 through FIG. 8 are merely illustrative of one embodiment of the invention, and other embodiments are contemplated as being within the scope of the invention. For example, each of the interfaces shown and described above need not be used. Or for example, command lines may be used in place of, or in combination with, the graphical user interfaces shown and described above. In addition, the management module 100 may function with little interaction from the administrator 280.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method for centrally managing a number of devices on a network, comprising:
determining whether a device interface for each of said number of devices conforms with a standard interface;
translating said device interface to conform with said standard interface when said device interface is nonconforming; and
managing said number of devices according to said standard interface.

2. A method as in claim 1, further comprising discovering said number of devices on said network.

3. A method as in claim 2, wherein discovering comprises:
a) obtaining network data for said number of devices; and
b) identifying said number of devices on said network based on said obtained network data.

4. A method as in claim 1, wherein managing said number of devices comprises monitoring said number of devices for an event.

5. A method as in claim 4, wherein monitoring said number of devices for an event comprises:
a) receiving a device trap representing said event from at least one of said number of devices; and
b) notifying an administrator of said event in response to receiving said device trap.

6. A method as in claim 1, wherein managing said number of devices comprises obtaining attributes for at least one of said number of devices.

7. A method as in claim 6, wherein managing said number of devices further comprises changing said attributes for said at least one device.

8. A method as in claim 1, wherein translating comprises:
reading said nonconforming device interface; and
cross-referencing at least part of said nonconforming device interface with said standard interface.

9. An apparatus for centrally managing a number of devices on a network, comprising:
computer readable storage media;
computer readable program code stored on said computer readable storage media, comprising:
a) program code for determining whether a device interface for each of said number of devices conforms with a standard interface;
b) program code for translating said device interface to conform with said standard interface when said device interface is nonconforming; and
c) program code for managing said number of devices according to said standard interface.

10. An apparatus as in claim 9, wherein said program code for managing is embodied at least in part in a network management application.

11. An apparatus as in claim 10, further comprising program code for discovering said number of devices on said network.

12. An apparatus as in claim 9, further comprising a graphical user interface (GUI) for user management of said number of devices.

13. An apparatus as in claim 9, wherein said program code for managing comprises program code for receiving a device trap from at least one of said number of devices.

14. An apparatus as in claim 9, wherein said program code for managing comprises program code for notifying an administrator when a device trap is received from at least one of said number of devices.

15. An apparatus as in claim 9, wherein said program code for managing comprises program code for obtaining attributes for at least one of said number of devices.

16. An apparatus as in claim 15, wherein said attributes include at least an indicator of the health of said at least one of said number of devices.

17. An apparatus as in claim 15, further comprising program code for changing at least one attribute of said at least one of said number of devices.

18. An apparatus as in claim 9, wherein said program code for translating comprises:
a translation library;
program code for reading said nonconforming device interface; and
program code for cross-referencing at least part of said nonconforming device interface with said standard interface based on said translation library.

19. An apparatus for centrally managing a number of network devices, comprising:
means for determining whether a device interface for said number of devices conforms with a standard interface; and
means for conforming a nonconforming device interface to said standard interface; and
means for managing said number of devices according to said standard interface.

20. An apparatus as in claim 19, wherein said managing means comprises means for monitoring at least one of said number of devices.

21. An apparatus as in claim 19, wherein said managing means comprises means for obtaining attributes for at least one of said number of devices.

22. An apparatus as in claim 19, wherein said conforming means comprises:
means for reading said nonconforming device interface; and
means for cross-referencing at least part of said nonconforming device interface with said standard interface.
